(19) United States
(12) Patent Application Publication
(10) Pub. No.: US 2011/0122831 A1
(43) Pub. Date: May 26, 2011

(54) APPARATUS AND METHOD FOR PROVIDING BANDWIDTH OF COGNITIVE RADIO SYSTEM

(75) Inventors: Sang-Won Kim, Daejeon (KR); Myung Sun Song, Daejeon (KR); Chang Hyun Park, Seoul (KR); Sun Min Lim, Daejeon (KR)

(73) Assignee: ELECTRONICS AND TELECOMMUNICATIONS RESEARCH INSTIT, Daejeon (KR)

(21) Appl. No.: 12/674,901

(22) PCT Filed: Jun. 13, 2008
(86) PCT No.: PCT/KR2008/003341

§ 371 Date: Feb. 23, 2010

(30) Foreign Application Priority Data
Aug. 24, 2007 (KR) 10-2007-0085430

(51) Int. Cl. H04W 72/04

(52) U.S. Cl. 370/329

(57) ABSTRACT

The present invention relates to an apparatus and method for providing a bandwidth of a cognitive radio system. An apparatus and method for providing a bandwidth of a cognitive radio system according to an exemplary embodiment of the present invention calculates an oscillation frequency of a local signal that changes, by a predetermined value, center frequencies of fractional bands as bands that arc not used temporally and spatially in partial bands of an externally provided broadcasting channel band. The apparatus and method for providing a bandwidth of a cognitive radio system outputs a first local signal at the calculated oscillation frequency, mixes the output first local signal and an external signal, and moves center frequencies of fractional bands of the external signal by a predetermined value. The apparatus and method for providing a bandwidth of a cognitive radio system Filters a frequency band that is higher than an upper limit of a pass band having a predetermined bandwidth among moved frequency bands of the fractional bands to extract a first signal. Then, the apparatus and method for providing a bandwidth of a cognitive radio system mixes the extracted first signal and a second local signal and moves the center frequencies of the fractional bands in the first signal. The apparatus and method for providing a bandwidth of a cognitive radio system filters a frequency band that is lower than a lower limit of the pass band among the moved frequency bands of the fractional bands to extract at least one fractional band. The apparatus and method for providing a bandwidth of a cognitive radio system provides the extracted fractional band to a terminal and a base station, thereby improving frequency utilization efficiency.

### TECHNICAL FIELD

The present invention relates to an apparatus and method for providing a bandwidth, and more particularly, to an apparatus and method for providing a bandwidth of a cognitive radio system.

The present invention was supported by the IT R&D program of MIC/IITA [2005-S-002-03, Development of Cognitive Radio Technology for Efficient Spectrum Utilization].

### BACKGROUND ART

In general, a cognitive radio system is a technology used to automatically search a frequency that is not used according to a region and time and enable target communication while protecting peripheral permitted wireless stations.

That is, after searching a frequency channel that is not used at the time of providing a service for each user, the searched frequency channel is provided to a secondary user. For example, when providing a service based on wireless communication to a secondary user, not a primary user, temporal and spatial inspections are performed on a frequency channel that is assigned to the primary user to provide a service, so as to search a frequency channel that is not used and provide the searched frequency channel to the secondary user.

As such, one of important factors that determine performance of the cognitive radio system is whether it can be achieved that a channel that is not currently used is effectively searched, a service suitable for the searched channel is selected, and the selected service is provided to the secondary user.

However, according to a general cognitive radio system, when a primary user system uses a portion of a bandwidth of a broadcasting channel band, both the primary user system and a secondary user system cannot use most of the broadcasting channel band, except for the portion of the bandwidth.

For example, in a multi-frequency assignment (FA) system, when a wireless apparatus having a small output of 200 KHz uses a broadcasting channel band having a bandwidth of 6 MHz, the existing primary and secondary user systems cannot use the other 5.8 MHz of bandwidth.

As another example, the IEEE802.22 system where the standardization is being made is used to provide a wireless Internet service using fractional bands that are not temporally and spatially used by TV signals or a primary user of a wireless apparatus in a band from 54 MHz to 862 MHz.

For this purpose, a base station and a terminal (customer premise equipment) that are secondary user systems of the IEEE802.22 system need to continuously monitor a channel state of very high frequency (VHF) and ultra high frequency (UHF) TV signal bands that have been allocated to a primary user.

That is, the base station and the terminal need to continuously monitor a channel utilization state of an entire frequency band in a range of 54 MHz to 862 MHz. As a monitored result, if the primary user appears while the secondary user uses an empty channel, the secondary user quickly empties the corresponding channel to move to another channel. However, in the related art, an effect that is generated on the basis of the suggested method in the related art is only a theoretical result, and a specific method that implements the corresponding system has not been suggested. The specific method has been required.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an apparatus and method for providing a bandwidth of a cognitive radio system, having advantages of providing fractional bands as partial bands of a broadcasting channel band to a terminal and a base station.

### Technical Solution

An exemplary embodiment of the present invention provides an apparatus for providing a bandwidth that provides an externally provided broadcasting channel band to a terminal or base station. The apparatus includes a local signal controller that calculates an oscillation frequency of a local signal that changes, by a predetermined value, center frequencies of fractional bands as bands that are not temporally and spatially used in partial bands of the broadcasting channel band; a first signal extractor that mixes a first local signal that is output at the calculated oscillation frequency and a signal of the broadcasting channel band and moves the center frequencies of the fractional bands by a predetermined value, and filters a frequency band that is higher than an upper limit of a pass band among moved frequency bands of the fractional bands to extract a first signal; and a second signal extractor that mixes a second local signal that is output at the calculated oscillation frequency and the extracted first signal and moves the moved center frequencies of the fractional bands again, and filters a frequency band that is lower than a lower limit of the pass band among the moved frequency bands of the fractional bands.

Another exemplary embodiment of the present invention provides an apparatus for providing a bandwidth that provides an externally provided broadcasting channel band to a terminal or base station. The apparatus includes a local signal controller that calculates an oscillation frequency of a local signal that changes, by a predetermined value, center frequencies of fractional bands as bands that are not temporally and spatially used in partial bands of the broadcasting channel band; a first signal extractor that mixes a first local signal that is output at the calculated oscillation frequency and a signal of the broadcasting channel band and moves the center frequencies of the fractional bands by a predetermined value, and filters a frequency band that is higher than an upper limit of a pass band among moved frequency bands of the fractional bands to extract a first signal; a second signal extractor that mixes a second local signal that is output at the calculated oscillation frequency and the extracted first signal and moves the moved center frequencies of the fractional bands again, and filters a frequency band that is lower than a lower limit of the pass band among the moved frequency bands of the fractional bands to extract a second signal; a third signal extractor that mixes a third local signal that is output at the calculated oscillation frequency and the signal of the broadcasting channel band and moves the center frequencies of the fractional bands by a predetermined value, and filters a frequency band that is higher than an upper limit of a pass band among the moved frequency bands of the fractional bands to extract a third signal; a fourth signal extractor that mixes a fourth local signal that is output at the calculated oscillation frequency and the extracted third signal and moves the moved center frequencies of the fractional bands again, and filters a frequency band that is lower than a lower limit of the pass band among the moved frequency bands of the fractional bands to extract a fourth signal; and an in-phase coupler that couples the extracted second signal and fourth signal with the same phase and provides the coupled signal to the terminal or base station.

Still another exemplary embodiment of the present invention provides a method of providing a bandwidth that provides an externally provided broadcasting channel band to a terminal or base station. The method includes calculating an oscillation frequency of a local signal that changes, by a predetermined value, a center frequency of at least one fractional band as a band that is not temporally and spatially used in partial bands of the broadcasting channel band; outputting first and second local signals at the calculated oscillation frequency; mixing the output first local signal and a signal of the broadcasting channel band and moving the center frequency of the at least one fractional band by a predetermined value; filtering a frequency band that is higher than an upper limit of a pass band among moved frequency bands of the at least one fractional band to extract a first signal; mixing the extracted first signal and the output second local signal and moving the moved center frequency of the at least one fractional band again; and filtering a frequency band that is lower than a lower limit of the pass band among the moved frequency bands of the at least one fractional band.

### Advantageous Effects

According to the exemplary embodiments that have been described above, at least one fractional band as a band that is not temporally and spatially used in partial bands of a broadcasting channel band is extracted, and the at least one extracted fractional band is provided to a terminal and a base station such that the fractional band can be used when each user uses a service, thereby improving frequency utilization efficiency.

### BRIEF DESCRIPTION OF THE DRAWINGS

FIG. 1 is a diagram specifically illustrating an apparatus for providing a bandwidth of a cognitive radio system according to an exemplary embodiment of the present invention.

FIG. 2 is a flowchart sequentially illustrating an operation process of an apparatus for providing a bandwidth of a cognitive radio system shown in FIG. 1.

FIG. 3 is a conceptual diagram illustrating types of fractional bands in an externally provided broadcasting channel band.

FIGS. 4 and 5 are conceptual diagrams illustrating a process of extracting fractional bands according to an exemplary embodiment of the present invention.

FIG. 6 is a diagram specifically illustrating a structure of an apparatus for providing a bandwidth according to another exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “section”, “-er (-or)”, “block” or “module” used herein mean a unit that processes at least one function or operation. This can be implemented by hardware, software, or a combination thereof.

In the present specification, a mobile station (MS) may designate a terminal, a mobile terminal (MT), a subscriber station (SS), a portable subscriber station (PSS), user equipment (UE), and an access terminal (AT), and may include a function of a portion or all of the mobile terminal, the subscriber station, the portable subscriber station, and the user equipment.

In the present specification, a base station (BS) may designate an access point (AP), a radio access station (RAS), a node B, a base transceiver station (BTS), and a mobile multihop relay (MMR)-BS, and may include a function of a portion or all of them.

Hereinafter, in an exemplary embodiment of the present invention, for better comprehension and ease of description, a portion or a group of bands that are not currently temporally and spatially used in partial bands of a broadcasting channel band is called a fractional band.

First, an apparatus for providing a bandwidth of a cognitive radio system according to an exemplary embodiment of the present invention will be described.

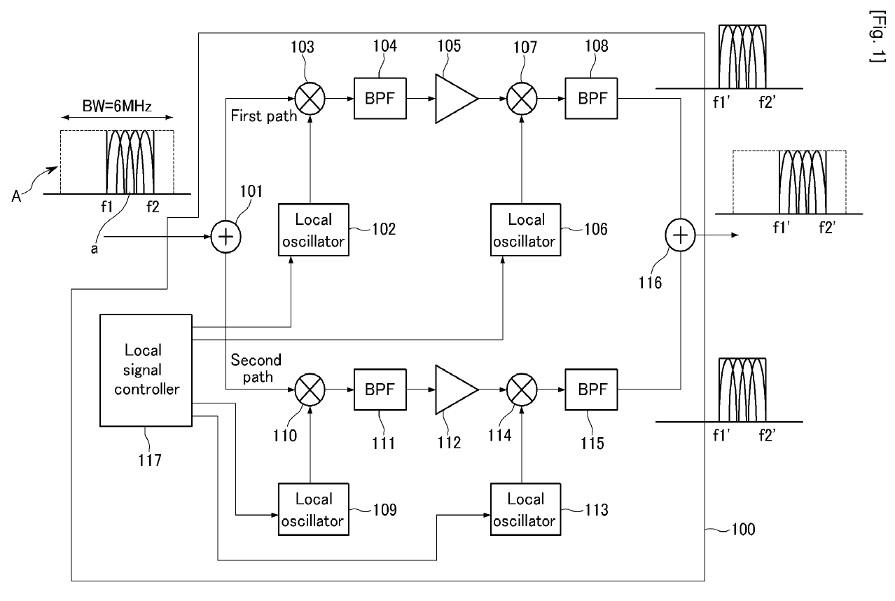

FIG. 1 is a diagram specifically illustrating an apparatus for providing a bandwidth of a cognitive radio system according to an exemplary embodiment of the present invention.

As shown in FIG. 1, an apparatus 100 for providing a bandwidth of a cognitive radio system according to an exemplary embodiment of the present invention includes an inphase distributor 101, a local oscillator 102, a mixer 103, a band pass filter 104, an amplifier 105, a local oscillator 106, a mixer 107, a band pass filter 108, a local oscillator 109, a mixer 110, a band pass filter 111, an amplifier 112, a local oscillator 113, a mixer 114, a band pass filter 115, an in-phase coupler 116, and a local signal controller 117.

The apparatus 100 for providing a bandwidth that has the above-described structure is located in a user terminal (not shown) and a base station (not shown). However, the present invention is not limited thereto, and may be located in another apparatus in some cases.

In the exemplary embodiment of the present invention that will be described below, a description is given to the case where the number of fractional bands as bands that can be temporally and spatially used in an externally provided broadcasting channel band is one.

In describing the exemplary embodiment of the present invention shown in FIG. 1, the local signal controller 117 will be first described in consideration of a signal flow.

The local signal controller 117 receives information on an externally received radio frequency signal A from an upper-level device, for example, a sensing manager (not shown).

For reference, the received information includes any one of the number of fractional bands as bands that can be temporally and spatially used in a broadcasting channel band of the radio frequency signal A, a bandwidth for each of the fractional bands, a center frequency for each of the fractional bands, a maximum frequency for each of the fractional bands, and a minimum frequency for each of the fractional bands.

The local signal controller 117 calculates local oscillation frequencies of the local oscillators 102, 106, 109, and 113 on the basis of the received information and output characteristics (e.g., pass bands) of the band pass filters 104, 108, 111, and 115, and transmits the calculated local oscillation frequencies to the local oscillators 102, 106, 109, and 113, respectively.

The in-phase distributor 101 divides the externally received radio frequency signal A into two signals (hereinafter referred to as “the first signal” and “the second signal”, for better comprehension and ease of description, in the exemplary embodiment of the present invention) having the same magnitude and phase, and distributes the first and second signals to paths, respectively.

First, a description is given on the basis of the first signal.

The local oscillator 102 oscillates a local signal that can change a center frequency of the first signal distributed by the in-phase distributor 101. At this time, the local oscillator 102 outputs the local signal at the oscillation frequency calculated by the local signal controller 117.

However, the present invention is not limited thereto, and in some cases, a user may arbitrarily control an oscillation frequency of a local signal.

The mixer 103 mixes the first signal A and the local signal output from the local oscillator 102 and generates an intermediate frequency signal. At this time, the generated intermediate frequency signal is a signal where a maximum frequency of a fractional band a in the corresponding signal is the same as a maximum frequency of a pass band that the corresponding signal needs to pass through.

As described above, the local signal controller 117 calculates oscillation frequencies of local signals on the basis of the information on the fractional band received from the upper-level device and the output characteristics of the band pass filters, and the local oscillator 102 outputs a local signal in the calculated oscillation frequency band.

Then, the mixer 103 moves a center frequency of the fractional band a in the first signal A by a predetermined value according to the output local signal, and matches the maximum frequency of the fractional band a with the maximum frequency of the pass band. This is to filter interference signals having a frequency that is higher than the maximum frequency of the fractional band a or used frequency bands through the band pass filter 104.

The band pass filter 104 passes only a portion of frequency bands of intermediate frequency signals output from the mixer 103, and filters all of frequency bands that are higher than the maximum frequency of the fractional band a, that is, frequency bands that are higher than an upper limit of a pass band.

For reference, the pass band of the band pass filter 104 does not depend on a predetermined value but depends on a center frequency of a signal in the band pass filter 104, and has a bandwidth that is wider than a bandwidth of the externally received radio frequency signal A. The characteristic (pass band) of the band pass filter 104 is recognized by the mixer 103 and the local signal controller 117 in advance.

The amplifier 105 amplifies the magnitude of the signal output from the band pass filter 104 by a predetermined value.

The local oscillator 106 oscillates a local signal that can change a center frequency of the signal that is output from the amplifier 105. At this time, the local oscillator 106 outputs a local signal at the oscillation frequency that is calculated by the local signal controller 117.

The mixer 107 mixes a signal output from the amplifier 105 and the local signal output from the local oscillator 106 and generates a signal having a predetermined frequency band. At this time, the generated signal is a signal in which a minimum frequency of the fractional band a in the corresponding signal is the same as a minimum frequency of a pass band that the corresponding signal needs to pass through.

That is, the local signal controller 117 calculates oscillation frequencies of local signals on the basis of the information on the fractional band received from the upperlevel device and the output characteristics of the band pass filters, and the local oscillator 106 outputs a local signal in the calculated oscillation frequency band.

Then, the mixer 107 moves a center frequency of the fractional band a in the corresponding signal by a predetermined value according to the output local signal, and matches the minimum frequency of the fractional band a with the minimum frequency of the pass band. This is to filter interference signals having a frequency that is lower than the minimum frequency of the fractional band a or used frequency bands through the band pass filter 108.

The band pass filter 108 passes only a portion of frequency bands of signals output from the mixer 107, and filters all of frequency bands that are lower than a minimum frequency of the fractional band a, that is, frequency bands that are lower than a lower limit of a pass band.

Next, a description is given on the basis of the second signal.

First, the local oscillator 109 oscillates a local signal that can change a center frequency of the second signal that is distributed by the in-phase distributor 101. At this time, the local oscillator 109 outputs a local signal at an oscillation frequency calculated by the local signal controller 117.

The mixer 110 mixes the second signal A and the local signal output from the local oscillator 109 and generates an intermediate frequency signal. At this time, the generated intermediate frequency signal is a signal in which a maximum frequency of a fractional band a in the corresponding signal is the same as a maximum frequency of a pass band that the corresponding signal needs to pass through.

This is to filter interference signals having a frequency that is higher than the maximum frequency of the fractional band a or used frequency bands through the band pass filter 111, as described above.

The band pass filter 111 passes only a portion of frequency bands of intermediate frequency signals output from the mixer 110, and filters all of frequency bands that are higher than a maximum frequency of the fractional band a in the intermediate frequency signals, that is, frequency bands that are higher than an upper limit of a pass band.

The amplifier 112 amplifies the magnitude of the signal output from the band pass filter 111 by a predetermined value.

The local oscillator 113 oscillates a local signal that can change a center frequency of a signal output from the amplifier 112. At this time, the local oscillator 113 outputs a local signal at an oscillation frequency calculated by the local signal controller 117.

The mixer 114 mixes the signal output from the amplifier 112 and the local signal output from the local oscillator 113 and generates a signal having a predetermined frequency band. At this time, the generated signal is a signal where a minimum frequency of a fractional band a in the corresponding signal is the same as a minimum frequency of a pass band that the corresponding signal needs to pass through.

This is to filter interference signals having a frequency that is lower than the minimum frequency of the fractional band a or used frequency bands through the band pass filter 115.

The band pass filter 115 passes only a portion of frequency bands of signals output from the mixer 114, and filters all of frequency bands that are lower than a minimum frequency of the fractional band a in the signals, that is, frequency bands that are lower than a lower limit of a pass band.

The in-phase coupler 116 couples signals output from the band pass filters 108 and 115 with the same phase, and provides the coupled signal to a user terminal or a base station.

In this way, the apparatus for providing a bandwidth according to the exemplary embodiment of the present invention extracts at least one fractional band that can be used in the externally provided broadcasting channel band and provides it to the user terminal or the base station. As a result, in the present invention, when a specific user utilizes a portion of the broadcasting channel band, it is possible to use a fractional band that is not currently used at the time of using a service even if the entire broadcasting channel does not become empty, which makes it possible to improve frequency utilization efficiency.

Next, a description is given of a method of providing a bandwidth according to an exemplary embodiment of the present invention on the basis of the apparatus for providing a bandwidth that has the above-described structure.

For reference, in the method of providing a bandwidth that will be described below, it is assumed that the number of fractional bands in an externally provided broadcasting channel band is two.

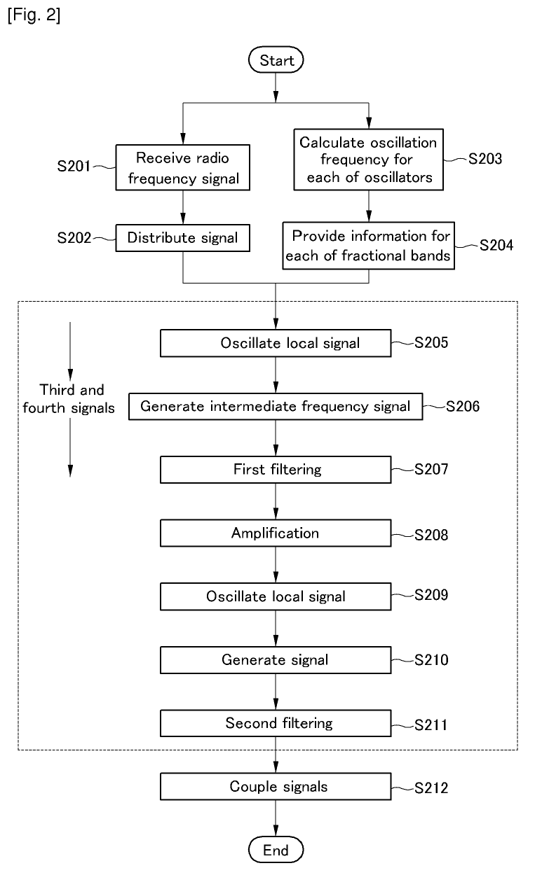

FIG. 2 is a flowchart sequentially illustrating an operation process of an apparatus for providing a bandwidth of a cognitive radio system according to an exemplary embodiment of the present invention.

As shown in FIG. 2, first, if a radio frequency signal B is provided from the outside (S201), the in-phase distributor 101 divides the provided radio frequency signal B into two signals (hereinafter referred to as “the third signal” and “the fourth signal”, for better comprehension and ease of description, in the exemplary embodiment of the present invention) having the same magnitude and phase, and distributes the third and fourth signals to paths, respectively (S202).

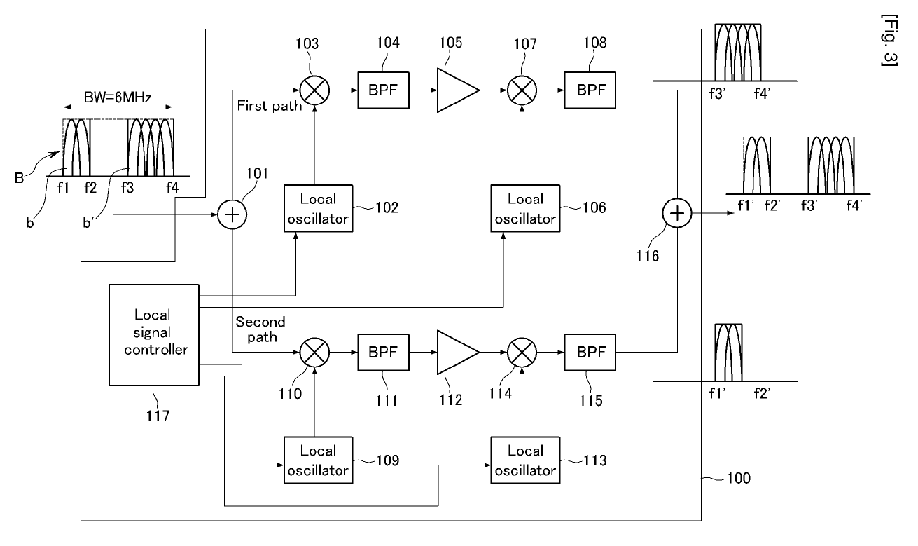

For reference, a display example of the radio frequency signal B that is provided from the outside is shown in FIG. 3.

FIG. 3 is a conceptual diagram illustrating types of fractional bands in an externally provided broadcasting channel band.

As shown in FIG. 3, the externally provided radio frequency signal B includes two fractional bands b and b′ having different sizes in an entire broadcasting channel band having a bandwidth of 6 MHz.

In consideration of a signal flow, the local oscillator 102, the mixer 103, and the band pass filter 104 constitute a first signal extractor, and the local oscillator 106, the mixer 107, and the band pass filter 108 constitute a second signal extractor. Further, the local oscillator 109, the mixer 110, and the band pass filter 111 constitute a third signal extractor, and the local oscillator 113, the mixer 114, and the band pass filter 115 constitute a fourth signal extractor.

However, the structures of the signal extractors are not limited thereto, and each signal extractor may further include another functional unit or exclude a component, if necessary.

Meanwhile, the local signal controller 117 receives information on the received radio frequency signal B from an upper level device, and calculates local oscillation frequencies of the local oscillators 102, 106, 109, and 113 on the basis of the received information and the output characteristics of the band pass filters 104, 108, 111, and 115 (S203).

Then, the local signal controller 117 transmits information on the calculated local oscillation frequencies to the local oscillators, respectively. At this time, the local signal controller 117 classifies the at least one calculated oscillation frequency for each of the fractional bands b and b′ and provides the classified oscillation frequency to each local oscillator (S204). For example, the local signal controller 117 provides an oscillation frequency related to the first fractional band b having a low frequency band between the two fractional bands b and b′ to the band pass filters 104 and 108.

Meanwhile, the local signal controller 117 provides an oscillation frequency related to the second fractional band b′ having a high frequency band between the two fractional bands b and b′ to the band pass filters 111 and 115.

Then, the local oscillator 102 oscillates a local signal that can change a center frequency of the third signal distributed by the in-phase distributor 101 (S205). As described above, the local oscillator 102 outputs the local signal at the oscillation frequency calculated on the basis of the first fractional band b.

The mixer 103 mixes the third signal and the local signal output from the local oscillator 102 and generates an intermediate frequency signal (S206). At this time, the generated intermediate frequency signal is a signal where a maximum frequency of the fractional band b in the corresponding signal is the same as a maximum frequency of a pass band that the corresponding signal needs to pass through. This is to filter interference signals having a frequency that is higher than a maximum frequency of the fractional band b or used frequency bands through the band pass filter 104.

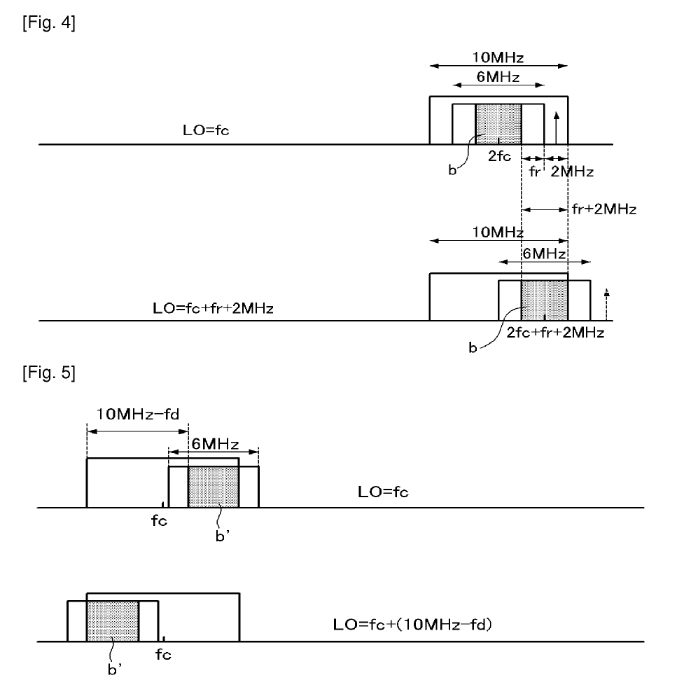

Then, the band pass filter 104 passes only a portion of frequency bands of intermediate frequencies output from the mixer 103 (S207), and filters all of frequency bands that are higher than a maximum frequency of the fractional band b, that is, frequency bands that are higher than an upper limit of a pass band. A display example thereof is shown in FIG. 4.

FIG. 4 is a conceptual diagram illustrating a process of extracting fractional bands according to an exemplary embodiment of the present invention.

As shown in FIG. 4, the band pass filter 104 filters all of frequency bands that are out of 10 MHz that is a pass band with respect to intermediate frequency signals output from the mixer 103. As a result, the interference signals having a frequency band that is higher than the maximum frequency of the fractional band b or used frequency bands are completely removed.

The amplifier 105 amplifies the magnitude of the signal output from the band pass filter 104 by a predetermined value (S208).

The local oscillator 106 oscillates a local signal that can change a center frequency of a signal output from the amplifier 105 (S209). At this time, the local signal is outputted at an oscillation frequency that is calculated on the basis of the first fractional band b.

The mixer 107 mixes the signal output from the amplifier 105 and the local signal output from the local oscillator 106 and generates a signal that has a predetermined frequency band (S210). At this time, the generated signal is a signal where a minimum frequency of a fractional band b in the corresponding signal is the same as a minimum frequency of a pass band that the corresponding signal needs to pass through.

This is to filter interference signals having a frequency that is lower than the minimum frequency of the fractional band b or used frequency bands through the band pass filter 108.

The band pass filter 108 passes only a portion of frequency bands of signals output from the mixer 107 (S211), and filters all of frequency bands that are lower than the minimum frequency of the fractional band b, that is, frequency bands that are lower than a lower limit of a pass band. A display example thereof is shown in FIG. 5.

FIG. 5 is a conceptual diagram illustrating a process of extracting fractional bands according to an exemplary embodiment of the present invention.

As shown in FIG. 5, the band pass filter 108 filters all of frequency bands that are out of 10 MHz that is a pass band with respect to intermediate frequency signals output from the mixer 107. As a result, interference signals having a frequency band that is lower than the minimum frequency of the fractional band b or used frequency bands are completely removed.

Meanwhile, a process of extracting the second fractional band b′ is as follows.

First, the local oscillator 109 oscillates a local signal that can change a center frequency of the fourth signal distributed by the in-phase distributor 101 (S202). At this time, the local oscillator 109 outputs a local signal at an oscillation frequency that is calculated on the basis of the second fractional band b′.

Then, the mixer 110 mixes the fourth signal and the local signal output from the local oscillator 109 and generates an intermediate frequency signal (S206). At this time, the generated intermediate frequency signal is a signal where a maximum frequency of the fractional band b′ in the corresponding signal is the same as a maximum frequency of a pass band that the corresponding signal needs to pass through.

This is to filter interference signals having a frequency that is higher than the maximum frequency of the fractional band b′ or used frequency bands through the band pass filter 111, as described above.

Then, the band pass filter 111 passes only a portion of frequency bands of intermediate frequency signals output from the mixer 110 (S207), and filters all of frequency bands that are higher than the maximum frequency of the fractional band b′ in the intermediate frequency signals, that is, frequency bands that are higher than an upper limit of a pass band.

The amplifier 112 amplifies the amplitude of the signal output from the band pass filter 111 by a predetermined value (S208).

Then, the local oscillator 113 oscillates a local signal that can change a center frequency of the signal output from the amplifier 112 (S209). At this time, the local oscillator 113 outputs a local signal at the oscillation frequency that is calculated on the basis of the second fractional band b′.

Then, the mixer 114 mixes the signal output from the amplifier 112 and the local signal output from the local oscillator 113 and generates a signal that has a predetermined frequency band (S210). At this time, the generated signal is a signal where a minimum frequency of the fractional band b′ in the corresponding signal is the same as a minimum frequency of a pass band that the corresponding signal needs to pass through.

This is to filter interference signals having a frequency that is lower than the minimum frequency of the fractional band b′ or used frequency bands through the band pass filter 115.

Then, the band pass filter 115 passes only a portion of frequency bands of signals output from the mixer 114 (S211), and filters all of frequency bands that are lower than the minimum frequency of the fractional band b′ in the signals, that is, frequency bands that are lower than a lower limit of a pass band.

Then, the in-phase coupler 116 couples the signals output from the band pass filters 108 and 115 with the same phase (S212) and provides it to a user terminal or base station.

In this way, the apparatus for providing a bandwidth according to the exemplary embodiment of the present invention previously recognizes information on fractional bands as bands that can be temporally and spatially used in the broadcasting channel band and a characteristic of each of the band pass filters, and calculates an oscillation frequency of a local signal for each of the local oscillators.

Then, if the apparatus for providing a bandwidth oscillates a local signal at the calculated oscillation frequency, it mixes the oscillated local signal and an external signal of a predetermined magnitude including fractional bands, and changes a center frequency for at least one fractional band. The apparatus for providing a bandwidth then filters the changed signal and extracts at least one fractional band, and provides the extracted fractional band to the user terminal or base station. Then, the user terminal or base station allows a user to use at least one desired service through the provided fractional band.

Accordingly, according to the exemplary embodiment of the present invention, if a portion of the externally provided broadcasting channel band is being used, not being able to use the entire broadcasting channel band can be prevented. That is, fractional bands that are not used at the present time are extracted from the broadcasting channel band and the extracted fractional bands are provided to the mobile terminal and the base station, thereby improving frequency utilization efficiency.

Next, an apparatus for providing a bandwidth according to another exemplary embodiment of the present invention will be described.

For reference, in the exemplary embodiment of the present invention that will be described below, it is assumed that the number of fractional bands in a broadcasting channel band is three.

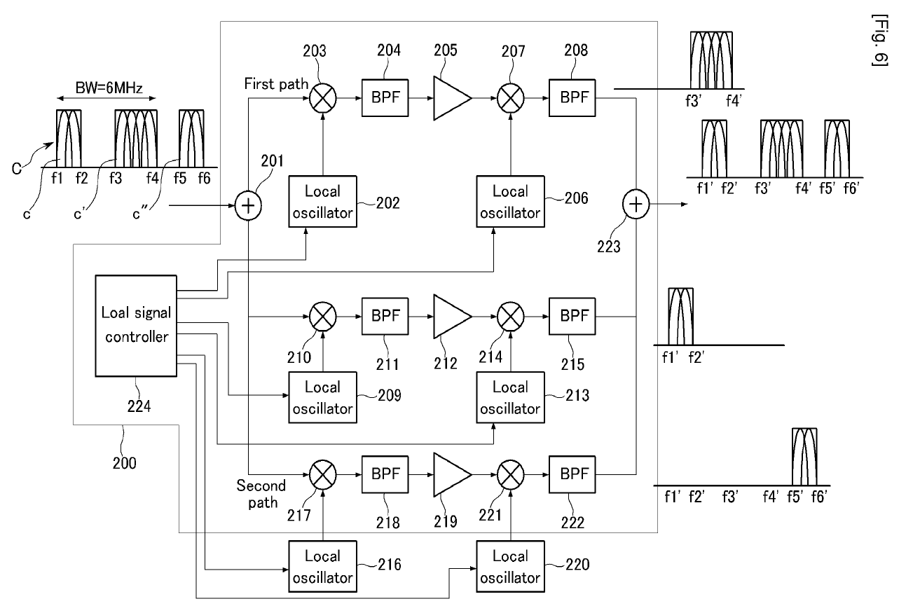

FIG. 6 is a diagram specifically illustrating an apparatus for providing a bandwidth according to another exemplary embodiment of the present invention.

As shown in FIG. 6, in the same manner as the apparatus 100 for providing a bandwidth shown in FIG. 1, an apparatus 200 for providing a bandwidth according to the current exemplary embodiment of the present invention includes an in-phase distributor 201, a local oscillator 202, a mixer 203, a band pass filter 204, an amplifier 205, a local oscillator 206, a mixer 207, a band pass filter 208, a local oscillator 209, a mixer 210, a band pass filter 211, an amplifier 212, a local oscillator 213, a mixer 214, a band pass filter 215, an in-phase coupler 223, and a local signal controller 224.

The apparatus 200 for providing a bandwidth that has the above-descried structure first extracts two fractional bands c and c′ in the order of low frequencies among fractional bands of an externally provided radio frequency signal C in the same manner as the above-described exemplary embodiment. That is, the apparatus for providing a bandwidth extracts the first fractional band c that corresponds to a lowest frequency band on a first path, and extracts the second fractional band c′ that corresponds to a second low frequency band on a second path.

The apparatus 200 for providing a bandwidth according to the current exemplary embodiment of the present invention may further include a local oscillator 216, a mixer 217, a band pass filter 218, an amplifier 219, a local oscillator 220, a mixer 221, and a band pass filter 222, differently from the apparatus 100 for providing a bandwidth shown in FIG. 1. This structure is to extract a third fractional band c″ that corresponds to a highest frequency band among the fractional bands of the radio frequency signal C.

The additional components are increased or decreased to correspond to the number of fractional bands in the externally provided broadcasting channel band. That is, the reason why the apparatus 200 for providing a bandwidth further includes the components differently from the apparatus 100 for providing a bandwidth shown in FIG. 1 is to extract the added fractional band because the number of fractional bands is increased by 1 as compared with that of FIG. 1.

The apparatus for providing a bandwidth according to the current exemplary embodiment of the present invention has the above-described structure, but the present invention is not limited thereto. In the present invention, at least one component may be further included, if necessary.

Specifically, if the radio frequency signal C is provided from the outside, the inphase distributor 201 divides the provided radio frequency signal C into three signals (hereinafter referred to as “the fifth signal”, “the sixth signal”, and “the seventh signal”, for better comprehension and ease of description, in another exemplary embodiment of the present invention) having the same magnitude and phase, and distributes the fifth to seventh signals to paths, respectively.

Meanwhile, the local signal controller 224 receives information on the provided radio frequency signal C from an upper-level device, and calculates local oscillation frequencies of the local oscillators 202, 206, 209, 213, 216, and 220 on the basis of the received information and output characteristics of the band pass filters 204, 208, 211, 215, 218, and 222.

The local signal controller 224 transmits information on the calculated local oscillation frequencies to the local oscillators, respectively. At this time, the local signal controller 224 classifies the at least one calculated oscillation frequency for each of the fractional bands c, c′, and c″ and provides the classified frequency to each local oscillator.

Then, the local oscillator 216 oscillates a local signal that can change a center frequency of the seventh signal distributed by the in-phase distributor 201. At this time, the local oscillator 216 outputs the local signal at the oscillation frequency that is calculated on the basis of the third fractional band c″, as described above.

The mixer 217 mixes the seventh signal and the local signal output from the local oscillator 216 and generates an intermediate frequency signal. At this time, the generated intermediate frequency signal is a signal where a maximum frequency of the fractional band c″ in the corresponding signal is the same as a maximum frequency of a pass band that the corresponding signal needs to pass through. This is to filter interference signals having a frequency that is higher than the maximum frequency of the fractional band c″ or used frequency bands through the band pass filter 218.

Then, the band pass filter 218 passes only a portion of frequency bands of intermediate frequency signals output from the mixer 217, and filters all of frequency bands that are higher than the maximum frequency of the fractional band c″, that is, frequency bands that are higher than an upper limit of a pass band.

The amplifier 219 amplifies the magnitude of the signal output from the band pass filter 218 by a predetermined value.

The local oscillator 220 oscillates a local signal that can change a center frequency of a signal output from the amplifier 219. At this time, the local oscillator 220 outputs a local signal at an oscillation frequency that is calculated on the basis of the third fractional band c″.

The mixer 221 mixes the signal output from the amplifier 219 and the local signal output from the local oscillator 220 and generates a signal that has a predetermined frequency band. At this time, the generated signal is a signal where a minimum frequency of a fractional band c″ in the corresponding signal is the same as a minimum frequency of a pass band that the corresponding signal needs to pass through.

The band pass filter 222 passes only a portion of frequency bands of signals output from the mixer 221, and filters all of frequency bands that are lower than the minimum frequency of the fractional band c″, that is, frequency bands that are lower than a lower limit of a pass band.

Then, the in-phase coupler 223 couples the signals output from the band pass filters 208, 215, and 222 with the same phase and provides them to a user terminal or a base station.

In this way, the apparatus 200 for providing a bandwidth according to another exemplary embodiment of the present invention extracts all of three fractional bands in an externally provided broadcasting channel band and provides the extracted fractional bands to the mobile terminal and the base station, thereby improving frequency utilization efficiency. At this time, the fractional bands c, c′, and c″ may be applied to fractional bands that are distant from each other as well as fractional bands that are adjacent to each other.

The exemplary embodiment of the present invention that has been described above may be implemented by not only an apparatus and a method but also a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An apparatus for providing a bandwidth that provides an externally provided broadcasting channel band to a terminal or base station, the apparatus comprising:
a local signal controller that calculates an oscillation frequency of a local signal that changes, by a predetermined value, center frequencies of fractional bands as bands that are not used temporally and spatially in partial bands of the broadcasting channel band;
a first signal extractor that mixes a first local signal output at the calculated oscillation frequency and a signal of the broadcasting channel band to move the center frequencies of the fractional bands by a predetermined value, and filters a frequency band that is higher than an upper limit of a pass band among moved frequency bands of the fractional bands to extract a first signal; and
a second signal extractor that mixes a second local signal output at the calculated oscillation frequency and the extracted first signal to move the moved center frequencies of the fractional bands again, and filters a frequency band that is lower than a lower limit of the pass band among the moved frequency bands of the fractional bands.

2. The apparatus of claim 1, wherein the first signal extractor includes:
a first local oscillator that outputs the first local signal at the calculated oscillation frequency;
a first mixer that mixes the output first local signal and the signal of the broadcasting channel band to move the center frequencies of the fractional bands by a predetermined value; and
a first band pass filter that filters a frequency band that is higher than an upper limit of the pass band among the moved frequency bands of the fractional bands to extract the first signal.

3. The apparatus of claim 1, wherein the second signal extractor includes:
a second local oscillator that outputs the second local signal at the calculated oscillation frequency;
a second mixer that mixes the output second local signal and the extracted first signal to move the moved center frequencies of the fractional bands again; and
a second band pass filter that filters a frequency band that is lower than a lower limit of the pass band among the moved frequency bands of the fractional bands.

4. The apparatus of claim 1, wherein:
information on the fractional bands includes any one of the number of fractional bands in the broadcasting channel band, bandwidths of the fractional bands, center frequencies of the fractional bands, maximum frequencies of the fractional bands, and minimum frequencies of the fractional bands; and
the local signal controller calculates an oscillation frequency of the local signal on the basis of the information on the fractional bands.

5. An apparatus for providing a bandwidth that provides an externally provided broadcasting channel band to a terminal or base station, the apparatus comprising:
a local signal controller that calculates an oscillation frequency of a local signal that changes, by a predetermined value, center frequencies of fractional bands as bands that are not used temporally and spatially in partial bands of the broadcasting channel band;
a first signal extractor that mixes a first local signal output at the calculated oscillation frequency and a signal of the broadcasting channel band to move the center frequencies of the fractional bands by a predetermined value, and filters a frequency band that is higher than an upper limit of a pass band among moved frequency bands of the fractional bands to extract a first signal;
a second signal extractor that mixes a second local signal output at the calculated oscillation frequency and the extracted first signal to move the moved center frequencies of the fractional bands again, and filters a frequency band that is lower than a lower limit of the pass band among the moved frequency bands of the fractional bands to extract a second signal;
a third signal extractor that mixes a third local signal output at the calculated oscillation frequency and the signal of the broadcasting channel band to move the center frequencies of the fractional bands by a predetermined value, and filters a frequency band that is higher than an upper limit of a pass band among the moved frequency bands of the fractional bands to extract a third signal;
a fourth signal extractor that mixes a fourth local signal output at the calculated oscillation frequency and the extracted third signal to move the moved center frequencies of the fractional bands again, and filters a frequency band that is lower than a lower limit of the pass band among the moved frequency bands of the fractional bands to extract a fourth signal; and
an in-phase coupler that couples the extracted second signal and fourth signal with the same phase and provides the coupled signal to the terminal or base station.

6. The apparatus of claim 5, wherein each of the first and third signal extractors includes:
a local oscillator that outputs at least one local signal at the calculated oscillation frequency;
a mixer that mixes the output local signal and the signal of the broadcasting channel band to move the center frequencies of the fractional bands by a predetermined value; and
a band pass filter that filters a frequency band that is higher than an upper limit of the pass band among the moved frequency bands of the fractional bands.

7. The apparatus of claim 5, wherein each of the second and fourth signal extractors includes:
a local oscillator that outputs at least one local signal at the calculated oscillation frequency;
a mixer that mixes the output local signal and the extracted first or third signal to move the moved center frequencies of the fractional bands again; and
a band pass filter that filters a frequency band that is lower than a lower limit of the pass band among the moved frequency bands of the fractional bands.

8. A method of providing a bandwidth that provides an externally provided broadcasting channel band to a terminal or base station, the method comprising:
calculating an oscillation frequency of a local signal that changes by a predetermined value a center frequency of at least one fractional band as a band that is not used temporally and spatially in partial bands of the broadcasting channel band;
outputting first and second local signals at the calculated oscillation frequency;
mixing the output first local signal and a signal of the broadcasting channel band to move the center frequency of the at least one fractional band by a predetermined value;
filtering a frequency band that is higher than an upper limit of a pass band among moved frequency bands of the at least one fractional band to extract a first signal;
mixing the extracted first signal and the output second local signal to move the moved center frequency of the at least one fractional band again; and
filtering a frequency band that is lower than a lower limit of the pass band among the moved frequency bands of the at least one fractional band.

9. The method of claim 8, wherein the calculating of the oscillation frequency of the local signal includes:
receiving information on the at least one fractional band from an upper-level device; and
recognizing a size of the pass band in advance and calculating an oscillation frequency for at least one local signal on the basis of the recognized size and the received information.

10. The method of claim 9, wherein the information on the at least one fractional band includes any one of the number of fractional bands in the broadcasting channel band, a bandwidth of the fractional band, a center frequency of the fractional band, a maximum frequency of the fractional band, and a minimum frequency of the fractional band.
